(19) United States
(12) Patent Application Publication
(10) Pub. No.: US 2021/0406888 A1
(43) Pub. Date: Dec. 30, 2021

(54) Systems And Methods For Remote Authentication, Authorization And Accounting System In Face-To-Face Commercial Activities

(71) Applicant: Vagaro Topco Holdings, LLC., Dublin, CA (US)

(72) Inventors: Fady E Helou, Pleasanton, CA (US); Eric Yu Lee, Los Altos, CA (US)

(21) Appl. No.: 17/201,655

(22) Filed: Mar. 15, 2021

Related U.S. Application Data
(60) Provisional application No. 63/045,531, filed on Jun. 29, 2020.

(51) Int. Cl. G06Q 20/40; H04L 29/06

(52) U.S. Cl. CPC G06Q 20/401; H04L 63/0892

(57) ABSTRACT

A method provides for facilitating a transaction. The method includes receiving, by a server, a transaction request related to a transaction between a service provider processing system and a user system from the service provider processing system via a first communication network; providing, by the server, user instructions related to the transaction to the user system via a second communication network; receiving, by the server, user information related to the transaction from the user system; verifying, by the server, the user information related to the transaction; and providing, by the server, a confirmation of the transaction to the service provider processing system in response to the verifying of the user information related to the transaction.

### RELATED APPLICATION

This application claims the benefit under 35 USC § 119 to U.S. provisional patent application Ser. No. 63/045,531, filed on Jun. 29, 2020, which is incorporated by reference herein in its entirety.

### BACKGROUND

The disclosure relates to payment processing and commercial activities in the face-to-face settings where agreement alteration, service quality and/or quantity adjustment, questionnaire taking, waiver submittal, attestation and acknowledgement, application forms and mandatory supporting documents are used.

Unless otherwise indicated herein, the approaches described in this section are not admitted to be prior art by inclusion in this section.

Today's current economic and COVID-19 pandemic climate have failed to adjust and address day to day business operations of payment processors, still requiring physical contact with various stakeholders and payment processing equipment. Despite best efforts, maintaining the cleanliness of equipment physically touched daily by the general public raises fears and concerns and contributes to the negative impact of the global economy.

Industry standards of processing payment with credit or debit cards, payees are usually required to produce signatures or punch in pins to authorize charges. In addition, the payees often add additional monies for gratuities or tips. In the current business climate, such actions are void of contactless. All these actions require the payees to come in touch with the businesses' equipment or assets and raise concerns regarding the contamination and the sanitation of the equipment.

In addition, certain businesses such as medical clinics or fitness studios require customers to fill out questionnaires or waiver forms upon checking-in for every appointment. Using any business provided equipment or assets to take the customer information also leads to concerns on contamination and lack of sanitation.

What is needed is a system and method for conducting payment transactions or information transfer transactions without physical contact with the transaction equipment.

### SUMMARY

The present disclosure provides for systems and methods for remote authentication, authorization, and accounting system in face-to-face commercial activities. A remote transaction processing system is a remote authentication, authorization and accounting system that provides a non-contact solution in the face-to-face commercial settings where customers' own devices are used for authentication, authorization and accounting in contrast to using the devices local to the businesses, in order to carry out the commercial activities. The remote transaction processing system provides authentication by acquiring customers' identity and/or eligibility for the service offerings. The remote transaction processing system provides authorization by acquiring customers' consent to the service agreements and/or payments. The remote transaction processing system provides accounting by acquiring customers' attestation, acknowledgement and/or agreement on the commercial terms, voluntary disclosure, and/or information sharing.

The remote transaction processing system provides several functionalities at the location where the commercial activities are being conducted with the customers also presenting at the same location. First, the remote transaction processing system acquires customers' signature, authentication code, authorization code, Personal Identification Number (PIN), driver's license number, One Time Password (OTP), Multi-Factor Authentication code, Personal Identifiable Information (PII), or any code privately known to the customers. Second, the remote transaction processing system delivers questionnaires, waiver forms and agreements to the customers' own personal device such as mobile phones, tablets and/or wearables, and accepts customers' answers to these documents. Third, the remote transaction processing system accepts customers' alterations to the quality and quantity of the services and/or payment terms, such as additional payment or multiple payment methods. Fourth, the remote transaction processing system completes the customers' checking-in process for a scheduled appointments and services.

The remote transaction processing system advantageously provides confidentiality. The remote transaction processing system applies end-to-end encryption to the customer's data from his or her own device to the processing server and thus data leakage to the middleman is greatly reduced.

The remote transaction processing system advantageously provides integrity. The remote transaction processing system applies a digital signature to the data submitted by the customer and thus any alternation to the submitted data can be detected.

The remote transaction processing system advantageously provides non-repudiation. The remote transaction processing system uses digital signature to ensure the submitted documents, acknowledgements, attestations, and/or authorizations cannot be denied by the customer later. The remote transaction processing system helps businesses ensure the binding of the agreements with customers.

The remote transaction processing system advantageously provides privacy: Because the customers use their own devices to submit the required information, the remote transaction processing system can redact the original information and only show the least amount of information necessary for the business teller to conduct the commercial activities. Customers' information is greatly protected and only visible to authorized personnel at the appropriate scope.

The remote transaction processing system advantageously minimizes risk and liability exposure: Unlike traditional automatic teller systems, point of sale systems, or check-in kiosks where the data intake device can be skimmed by third party devices, The remote transaction processing system allows customers to use their own devices to submit sensitive information. The remote transaction processing system reduces both customers' risks as well as businesses' risks in the likelihood and the scope of data breach.

The remote transaction processing system advantageously provides personal health and equipment hygiene: During the global COVID-19 pandemic, personal health and hygiene of touchable devices are the concern for the face-to-face commercial activities. The remote transaction processing system allows customers to interact with the businesses via their personal devices and therefore reduces hygiene concerns and the chance of cross contamination.

In one embodiment, the disclosure provides a method for facilitating a transaction. The method comprises receiving, by a server, a transaction request related to a transaction between a service provider processing system and a user system from the service provider processing system via a first communication network; providing, by the server, user instructions related to the transaction to the user system via a second communication network; receiving, by the server, user information related to the transaction from the user system; verifying, by the server, the user information related to the transaction; and providing, by the server, a confirmation of the transaction to the service provider processing system in response to the verifying of the user information related to the transaction.

In one embodiment, the disclosure provides for a system comprising a memory storing computer-executable instructions, and a processor executing the computer-executable instructions to perform any of the methods described herein.

In one embodiment, the disclosure provides for non-transitory computer-readable storage medium comprising instructions executable by a processor, the instructions comprising: instructions for performing any of the methods described herein.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a block diagram illustrating a remote transaction processing system according to one embodiment.

FIG. 2 is a data flow diagram illustrating a payment application of a remote transaction processing system according to one embodiment.

FIG. 3 is a data flow illustrating a document check in application of a remote transaction processing system according to one embodiment.

### DETAILED DESCRIPTION

Various embodiments of the present invention are now described with reference to the figures where like reference numbers indicate identical or functionally similar elements. Also in the figures, the left most digits of each reference number corresponds to the figure in which the reference number is first used.

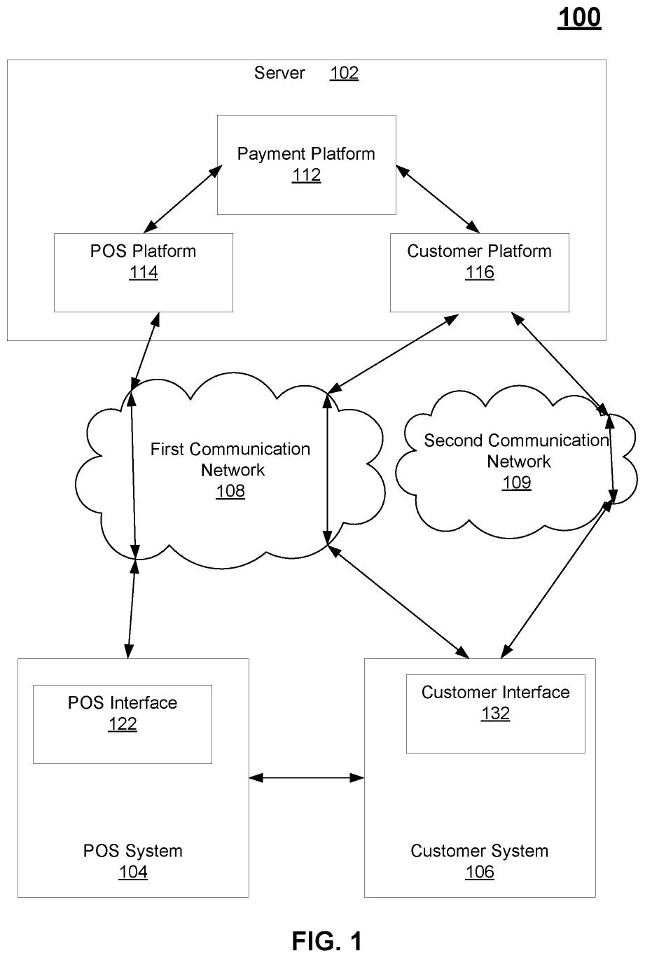

FIG. 1 is a block diagram illustrating a remote transaction processing system 100 according to one embodiment.

The remote transaction processing system 100 enables customers to use their own devices, such as phones, tablets and wearables, to complete the payment process, in essence providing contactless face to face purchasing. In various embodiments, the remote transaction processing system 100 resolves current merchant conflicts in day to day operation in dealing with customers in person. For example, the remote transaction processing system 100 finishes all required questionnaires and waivers during appointments and adopts a contactless checking-in procedure.

The remote transaction processing system 100 comprises a server 102, a service provider processing system 104, and a customer system 106. The customer system 106 is also referred to herein as user system 106 for ease of discussion without limiting the invention. The user system 106 is a personal device of the user, and is typically only touched by the user. The user system 106 may be, for example, a mobile phone, tablet, or wearable. The user system 106 may be, for example, email, social media or other electronic communication that a user controls. In one embodiment, the service provider processing system 104 is a point of service (POS) system, and also is referred to herein as a POS system 104 for ease of discussion without limiting the invention. In one embodiment, the service provider processing system 104 is a check-in processing terminal.

The server 102 receives and verifies payment authentication and authorization with signatures, pins or any credentials privately known to the payee (the user of the customer system 106).

The customer system 106 allows a user to add or adjust the quality or quantity of the services or products during the payment or check-out process.

Businesses taking questionnaires, waivers, attestations, acknowledgements, or the like from customers may use service provider processing system 104 to provide the user such information to the customer system 106 using the server 102.

Further, a business taking mandatory and prerequisite documentation from customers may use the service provider processing 104 to make provide the documentation to the user system 106 using the server 102.

In various embodiments, customers checking-in for scheduled appointments or services and electing optional service upgrades check in using the user system 106 receiving information from the service provider processing system 104 without persona physical contact by the user with the service provider processing system 104 and from the server 102, also without personal physical contact with the server 102.

The server 102 comprises a payment platform 112, a service provider processing or POS platform 114, and a customer platform 116. The payment platform 112 processes payments for POS providers and documentation for check-in at service providers from the POS platform 114, which communicates via the first communication network 108 with a server provider processing or POS interface 122 of the POS system 104. The payment platform 112 processes payments for customers at POS providers or documentation for customers at check-in at service providers from the customer platform 116, which communicates via the first communication network 108 or the second communication network 109 or both with a customer interface 132 of the customer system 106. The payment platform 112 may redact the customer information sent to the POS system 104 so that the POS system 104 receives only the customer information that is sufficient to complete the transaction.

The server 102 receives a transaction request related to a transaction between the service provider processing system 104 and a user system 106 from the service provider processing system 104 via the first communication network 108. In one embodiment, the transaction is related to a service to be provided by the service provider processing system 104 to the user system 106, The server 102 provides user instructions related to the transaction to the user system 106 via the second communication network 109. The user instructions are included in at least one selected from a group of a text message, visually encoded message (e.g., QR code), and radio encoded message (e.g., near field communication (NFC) and Bluetooth) to the user system 106 and include a uniform resource identifier that requests the user information related to the transaction. The uniform resource identifier may be, for example, a webpage, email, voice over Internet Protocol (VoIP) endpoints and mobile applications. In one embodiment, the user instructions include at least one form to be completed by the user system, and the user information includes information that completes the form and a digital signature of the user. A side channel (not shown) may be used for transferring an encryption key between the user system 106 and the service provider processing system 104 that is used to encrypt and decrypt data. The server 102 does not have access to the encryption key. The end-to-end encryption allows encrypted data to be communicated between the ends of the communication, which are the user system 106 and service provider processing system 104. In some embodiments, the server 104 has access to the encryption key and can encrypt and decrypt data that is communication with the user system 106 and the service provider processing system 104.

In various embodiments, the transaction is related to a service provided by the service provider processing system 104 to the user system 106. The user instructions include payment information related to the transactions. The user information includes information that completes the payment information and also includes a digital approval of the transaction by the user system 106. In various embodiments, the digital approval of the user includes at least one selected from a group of a PIN, handwritten signature, biometrics, digital signature, user knowledge and user identifier.

The server 102 receives user information related to the transaction from the user system 106. The server 102 verifies the user information related to the transaction. The server 102 provides a confirmation of the transaction to the service provider processing system 104 in response to the verifying of the user information related to the transaction.

In one embodiment, the second communication network 109 is the first communication network 108.

In one embodiment, the first communication network 108 is an Internet, and the second communication network 109 is a cellular network. In various embodiments, each of the first communication network 108 and the second communication network 109 are at least one selected from a group Internet, cellular network, near field communication, Bluetooth, radio encoded communication and visually encoded communication.

Although the server 102 and the service provider processing system 104 are described as separate systems, the server 102 and the service provider processing system 104 may be co-located in the same device.

Although the server 102 and the service provider processing system 104 are described as being separate systems at different locations, the server 102 and the service provider processing system 104 may be co-located in the same location.

The server 102 provides a software application to the user system 106 via the first communication network 108 in response to a user selection of the uniform resource identifier.

The server 102 provides instructions to the service provider processing system 104 to provide an electronic notification of the transaction to the user system 106. In some embodiments, the electronic notification is at least one selected from a group of a receipt, a confirmation, an invoice, an authorization code, and an acknowledgement.

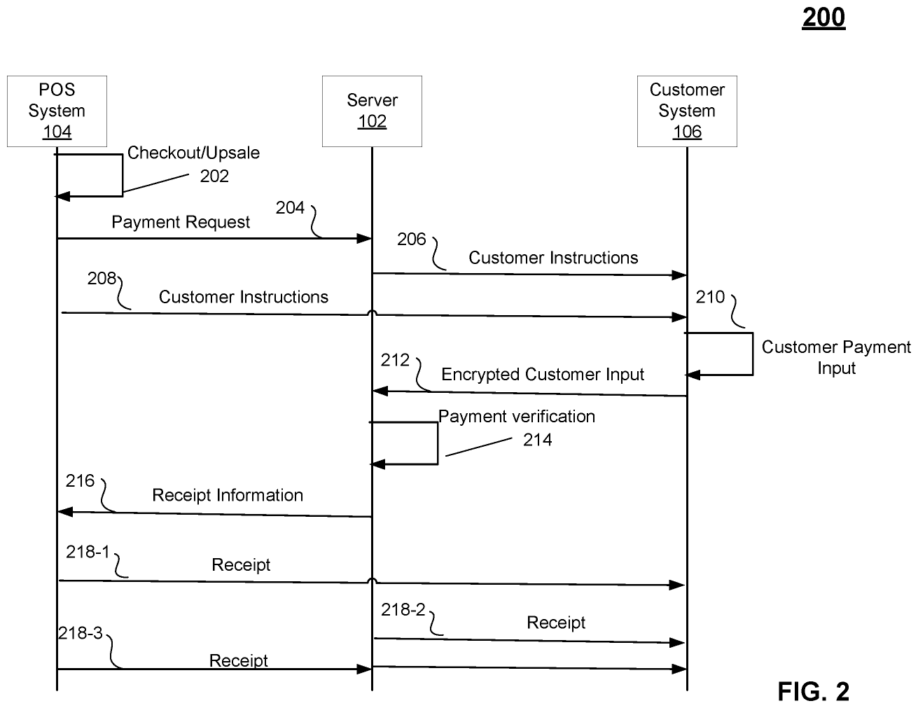

FIG. 2 is a data flow diagram illustrating a payment application 200 of the remote transaction processing system 100 according to one embodiment. The service provider initiates, at 202, a checkout or upsale for a customer using the POS system 104. The POS system 104 sends, at 204, a payment request to the server 102. Based on the payment request and the associated relationship between the POS provider and the server 102, the server 102 sends user or customer instructions, at 206, via the second network 109 or the first network 108 to the customer system 106. In various embodiments, the server 102 delivers the data acquisition instructions to the customer system 106 through text messages (including but not limited to SMS, MMS, online chat platforms, commercially available chat applications or any telecommunication message delivering system), push notifications to smart phones and computers, Near Field Communication (NFC), visually encoded messages (such as QR code and bar code) and radio encoded messages. In one embodiment, the POS system 104 directly sends, at 208, the user instructions to the customer system 106 via the second network 109 or as a visually encoded message or a radio encoded message.

The data acquisition instructions trigger the launch of pre-installed computer or mobile applications or web browsers to load the data intake web portal, where a piece of embedded encryption software along with the encryption key material is delivered by the server 102 to the customer system 106. The embedded encryption software, executed by the customer system 106, encrypts the acquired data from the customers, generates digital signatures for the data and forwards the encrypted payload to the server 102. The user inputs, at 210, customer payment information, tips, and the like, which are encrypted by the customer system 106 and sent, at 212, to the server 102.

The server 102 decrypts the payload, verifies the digital signatures, validates the business information in the payload, performs further business oriented actions such as checking-in and payment, and finally notifies the POS system 104 at the business location to print the invoice, receipt or error message.

The server 102 verifies, at 214, the payment information from the customer system 106, and sends, at 216, receipt information to the POS system 104. The POS system 104 sends, at 218-1, an electronic receipt to the customer system 106. The server 102 sends, at 218-2, an electronic receipt to the customer system 106. In one embodiment, the server 102 may send, at 218-2, the receipt information, in parallel with the sending at 216 of the receipt. In yet another embodiment, the POS system 104 sends, at 218-3, the electronic receipt to the server 102, which in turns sends the electronic receipt to the customer system 106.

The flow 200 and the system 100 provide that the user only has physical contact with their own device, namely, the customer system 106, and has no physical contact with the POS system 104 or the server 102.

The data flow 200 is described for a first illustrative embodiment for the flow after the service is rendered or purchased goods scanned to the point of sale system 104. During checkout at 202, the customer makes payment with credit cards, mobile devices, or any payment devices where the customer's signature is required to attest the authenticity of the payment. The server 102 delivers, at 206, the signing instruction to the customer system 106 and the customer completes the signature on his or her own personal device. The encryption software executed by the customer system 106 digitally signs and encrypts, at 212, the payload for delivery to the server 102. Once the server 102 verifies, at 214, the authenticity and integrity of the payload, the server 102 instructs, at 216, the point of sale system 104 to print, at 218, the final receipt for the customer.

The data flow 200 is described for a second illustrative embodiment for the flow after the service is rendered or purchased goods scanned to the point of sale system 104. The customer makes payment at checkout 202 with credit cards, mobile devices, or any payment devices where the customer is required to enter authentication and/or authorization code such as Personal Identification Number (PIN), Driver's License Number, One Time Password (OTP) or any code privately known to the customer. The server 102 delivers, at 206, the code-taken instruction to the customer system 106 and the customer enters the code on his or her own customer system 106. The encryption software executed by the customer system 106 digitally signs and encrypts, at 212, the payload for delivery to the server 102. Once the server 102 verifies, at 214, the authenticity and integrity of the payload, the server 102 instructs, at 216, the point of sale system 104 to print the final receipt for the customer.

The data flow 200 is described for a third illustrative embodiment for the flow after the service is rendered or purchased goods scanned to the point of sale system 104. The customer is presented at checkout 202, with the tentative service invoice or charging slip for making payment adjustment such as adding gratuity, adjusting quantity, entering the promotional code, discount code or rebate code, and/or attesting the eligibility of the purchasing terms. The server 102 delivers, at 206, the payment adjustment instruction to the customer system 106 and the customer completes the adjustment on his or her own consumer device. The encryption software executed by the customer system 106 digitally signs and encrypts, at 212, the payload for delivery to the server 102. Once the server 102 verifies, at 214, the authenticity and integrity of the payload, the server 102 instructs, at 216, the point of sale system 104 to print, at 218, the final receipt for the customer.

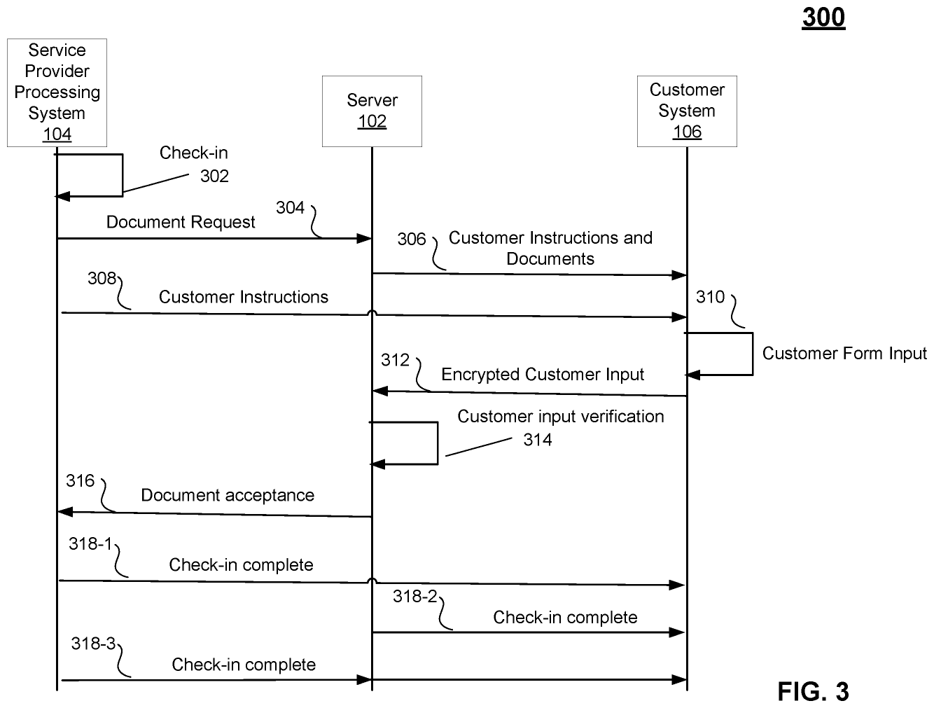

FIG. 3 is a data flow illustrating a document check in application 300 of the remote transaction processing system 100 according to one embodiment. The service provider initiates, at 302, a check-in process for a customer using the service provider processing system 104. The service provider processing system 104 sends, at 304, a document request to the server 102. Based on the document request and the associated relationship between the service provider and the server 102, the server 102 sends user or customer instructions and documents, at 306, via the second network 109 or the first network 108 to the customer system 106. In one embodiment, the service provider processing system 104 directly sends, at 308, the user instructions and documents to the customer system 106 via the second network 109 or as a visually encoded message or a radio encoded message. The user inputs, at 310, customer form information, and identifying documents (such as driver's license, insurance card and the like), which are encrypted by the customer system 106 and sent, at 312, to the server 102. The server 102 verifies, at 314, the document information from the customer system 106, and sends, at 316, document acceptance to the service provider processing system 104. The service provider processing system 104 sends, at 318-1, an electronic check-in complete notification to the customer system 106. The server 102 sends, at 318-2, an electronic check-in complete notification to the customer system 106. In one embodiment, the server 102 may send at 318-2 the electronic check-in complete notification, in parallel with the sending at 316 of the document acceptance. In yet another embodiment, the POS system 104 sends, at 318-3, the electronic check in complete notification to the server 102, which in turns sends the electronic check-in complete notification to the customer system 106.

The flow 300 and the system 100 provide that the user only has physical contact with their own device, namely, the customer system 106, and has no physical contact with the service provider processing system 104 or the server 102.

The data flow 300 is described for a first illustrative embodiment for the flow during a check-in by the customer for a schedule appointment or service. The service provider requires the customer to authorize and accept a waiver form or acknowledge the service terms. The server 102 delivers, at 306, the forms to the customer system 106 for the customer's authorization and acknowledgement. After the customer submits, at 312, the forms on his or her own customer system 106, the checking-in process is completed.

The data flow 300 is described for a second illustrative embodiment for the flow during a check-in by the customer for a scheduled appointment or service. The service provider requires the customer to submit mandatory documentation such as copy of driver's license, copy of passport, copy of payment guarantees, copy of insurance information, and/or copy of payment information. The server 102 delivers, at 306, the uniform resource identifier of the document importing software to the customer system 106. The customer follows the instruction and submits copies of the required documents. The document importing software running on the customer system 106 digitally signs the submitted documents for integrity and non-repudiation assurance and encrypts, at 312, the payload for secured end-to-end transmission to the server 102.

Reference in the specification to “one embodiment”, “an embodiment”, “various embodiments” or “some embodiments” means that a particular feature, structure, or characteristic described in connection with these embodiments is included in at least one embodiment of the invention, and such references in various places in the specification are not necessarily all referring to the same embodiment.

To the extent that section headings are used, they should not be construed as necessarily limiting.

Some portions of the detailed description above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the disclosure include process steps and instructions described herein in the form of an algorithm. It should be noted that the process steps and instructions of the disclosure could be embodied in software, firmware or hardware, and when embodied in software, could be downloaded to reside on and be operated from different platforms used by a variety of operating systems.

The disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium suitable for storing electronic instructions, and each coupled to a computer system bus. Furthermore, the processors referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the systems and methods of the disclosure are not described with reference to any particular programming language. It will be appreciated that a variety of programming languages may be used to implement the teachings of the present invention as described herein, and any references below to specific languages are provided for disclosure of enablement and best mode of the present invention.

As used in the description herein and throughout the claims that follow, “a”, “an”, and “the” includes plural references unless the context clearly dictates otherwise.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. A method for facilitating a transaction, the method comprising:
receiving, by a server, a transaction request related to a transaction between a service provider processing system and a user system from the service provider processing system via a first communication network;
providing, by the server, user instructions related to the transaction to the user system via a second communication network;
receiving, by the server, user information related to the transaction from the user system;
verifying, by the server, the user information related to the transaction; and
providing, by the server, a confirmation of the transaction to the service provider processing system in response to the verifying of the user information related to the transaction.

2. The method of claim 1, wherein the second communication network is the first communication network.

3. The method of claim 1, wherein the first communication network is an Internet and the second communication network is a cellular network.

4. The method of claim 1, wherein each of the first and second communication networks are at least one selected from a group Internet, cellular network, near field communication, Bluetooth, radio encoded communication and visually encoded communication.

5. The method of claim 1, wherein the server and the service provider processing system are co-located in the same device.

6. The method of claim 1, wherein the server and the service provider processing system are co-located in the same location.

7. The method of claim 1, wherein the user instructions are included in at least one selected from a group of a text message, visually encoded message, and radio encoded message to the user system and include a uniform resource identifier that requests the user information related to the transaction.

8. The method of claim 7, further comprising providing, by the server, a software application to the user system via the first communication network in response to a user selection of the uniform resource identifier.

9. The method of claim 1, wherein the transaction is related to a service provided by the service provider processing system to the user system, the user instructions include payment information related to the transactions, and the user information includes information that completes the payment information and also includes a digital approval of the transaction by the user system.

10. The method of claim 9, wherein the digital approval includes at least one selected from a group of a PIN, handwritten signature, biometrics, digital signature, user knowledge and user identifier.

11. The method of claim 1, wherein the transaction is related to a service to be provided by the service provider processing system to the user system, the user instructions include at least one form to be completed by the user system, and the user information includes information that completes the form and a digital signature of the user.

12. The method of claim 1, further comprising providing, by the server, instructions to the service provider processing system to provide an electronic notification of the transaction to the user system.

13. The method of claim 12, wherein the electronic notification is at least one selected from a group of a receipt, a confirmation, an invoice, an authorization code, and an acknowledgement.

14. The method of claim 1, wherein the service provider processing system is a point of service system.

15. The method of claim 1, wherein the service provider processing system is a check-in processing terminal.

16. A system comprising:
a memory storing computer-executable instructions; and
a processor executing the computer-executable instructions to perform:
receiving, by a server, a transaction request related to a transaction between a service provider processing system and a user system from the service provider processing system via a first communication network;
providing, by the server, user instructions related to the transaction to the user system via a second communication network;
receiving, by the server, user information related to the transaction from the user system;
verifying, by the server, the user information related to the transaction; and
providing, by the server, a confirmation of the transaction to the service provider processing system in response to the verifying of the user information related to the transaction.

17. A non-transitory computer-readable storage medium comprising instructions executable by a processor, the instructions comprising:
instructions for performing:
receiving, by a server, a transaction request related to a transaction between a service provider processing system and a user system from the service provider processing system via a first communication network;
providing, by the server, user instructions related to the transaction to the user system via a second communication network;
receiving, by the server, user information related to the transaction from the user system;
verifying, by the server, the user information related to the transaction; and
providing, by the server, a confirmation of the transaction to the service provider processing system in response to the verifying of the user information related to the transaction.
